(19) United States
(12) Patent Application Publication
(10) Pub. No.: US 2026/0346775 A1
(43) Pub. Date: Nov. 5, 2026

(54) PADDOCK CLEANER WITH DUMPING MECHANISM

(71) Applicant: Kevin Fowler, Kidderminster (GB)

(72) Inventor: Kevin Fowler, Kidderminster (GB)

(21) Appl. No.: 19/662,626

(22) Filed: Apr. 29, 2026

Related U.S. Application Data
(60) Provisional application No. 63/797,167, filed on Apr. 30, 2025.

(51) Int. Cl. B60P 1/16; A01K 1/01; B60P 1/28; B66F 9/02

(52) U.S. Cl. CPC B60P 1/16; A01K 1/01; B60P 1/283; B66F 9/02

(57) ABSTRACT

A self-dumping paddock blade that dumps its own load without any lifting being required by the operator. A lifting assembly is attached to a paddock blade to make the self-dumping paddock blade. The lifting assembly includes an upper U-shaped frame, a lower U-shaped frame, and two pre-tensioned gas struts that provide the lifting force. The bottom ends of the two frames are attached by a latch, and the terminal ends of the two frames are rotatably connected. When the latch is released, the two pre-tensioned gas struts raise the bottom end of the upper frame into the air. The paddock blade is attached to the upper frame, and the closed end of the blade is also raised into the air. This dumps the contents in the bed out of the paddock blade.

### CROSS REFERENCE TO RELATED APPLICATIONS

This application claims the benefit of U.S. Provisional Patent Application 63/797,167, filed on Apr. 30, 2025, incorporated herein by reference.

### STATEMENT REGARDING FEDERALLY SPONSORED RESEARCH AND DEVELOPMENT

Not applicable.

### FIELD OF THE DISCLOSURE

This invention relates generally to manure collection apparatuses commonly known as paddock blades, and more particularly to a self-dumping paddock blade that does not require any lifting by the operator.

### BACKGROUND

Paddock cleaning blades are used to quickly remove manure, rocks, sticks, and other both organic and non-organic matter from paddocks and pastures. Traditionally, pastures are open areas and paddocks are enclosed; both areas typically have cows, horses and other hooved animals. Manure is dropped in both areas, paddocks and pastures, and paddock blades are used to remove the manure from both. Cables are attached to the open end of a paddock blade and the blade is dragged through the paddock or pasture.

The weight and overall design of the blade cause anything laying on the ground, such as manure, to be gathered into the bed of the paddock blade. After collecting all of the manure in a paddock or pasture, the paddock blade is taken to a dumping area and the operator lifts the bottom end of the paddock blade to dump the load out of the blade.

Therefore, there is a need for a paddock blade that is self-dumping. The ideal device would be a lifting assembly that could be attached to a paddock blade before gathering manure, and after gathering the manure the lifting assembly would lift one end of the paddock blade thereby dumping the contents out of the blade, without requiring any lifting by the operator. The present invention accomplishes these objectives.

### SUMMARY

The present device is a self-dumping paddock blade that is able to dump its load without any lifting being required by an operator. The self-dumping paddock blade comprises a paddock blade that is adapted to be dragged through a paddock whereby a load is gathered inside a bed of the paddock blade and a dumping assembly that is attached to the outside of the paddock blade.

The dumping assembly comprises a lower frame having a U shape, an upper frame having a similar U shape, and two pre-tensioned gas struts. Each gas strut has a lower end that is connected to the lower frame and an upper end that is connected to the upper frame. The lower and upper frames are rotatably connected at terminal ends of the frames and releasably connected at bottom ends of the frames. The pre-tensioned gas struts cause the bottom end of the upper frame to rise when a latch at the bottom end of the frames is pressed, thereby releasing the upper frame from the bottom frame.

The present invention allows ranchers and others that must clean up after horses to continue to do so, even after they can no longer lift one end of a paddock blade. Other features and advantages of the present invention will become apparent from the following more detailed description, taken in conjunction with the accompanying drawings, which illustrate, by way of example, the principles of the invention.

### DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 is a perspective view of the preferred embodiment of the present invention in the lowered position;

FIG. 2 is a perspective view of the preferred embodiment of the present invention in the raised position;

FIG. 3 is a side view of an alternative embodiment of the present invention in the lowered position;

FIG. 4 is a side view of the alternative embodiment of the present invention in the raised position;

FIG. 5 is a perspective view of the alternative embodiment of the present invention in the lowered position;

FIG. 6 is a perspective view of the alternative embodiment of the present invention in the raised position; and

FIG. 7 is a flow chart showing exemplary steps for using the present invention.

### DETAILED DESCRIPTION

The following description of illustrative embodiments is merely exemplary in nature and is not intended to limit the disclosure, its application, or uses.

Unless otherwise defined, all technical and scientific terms used herein have the same meaning as commonly understood by one of ordinary skill in the art. The terminology used in the description is for describing particular embodiments only and is not intended to be limiting.

As used herein, the singular forms “a,” “an,” and “the” include plural referents unless the context clearly dictates otherwise. The terms “comprising,” “including,” and “having” are intended to be inclusive and mean that there may be additional elements other than the listed elements. When the word “each” is used to refer to an element that was previously introduced as being at least one in number, the word “each” does not necessarily imply a plurality of the elements, but can also mean a singular element.

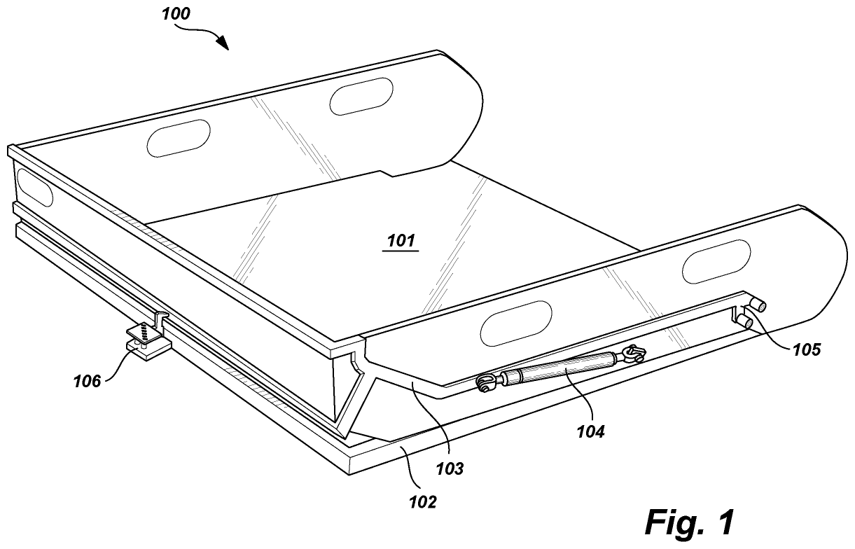

FIG. 1 is a perspective view of the preferred embodiment of the present self-dumping paddock blade 100 in the lowered position. The self-dumping paddock blade 100 comprises a paddock blade 101 and a lifting assembly that is attached to the paddock blade 101. The paddock blade 101 is similar to paddock blades currently on sale, or in use. The paddock blade 101 has an open end that collects objects, including manure, as the blade 101 is dragged through a paddock or pasture. When done, the operator needs to dump the contents of the paddock blade 101. This is where the benefit of the present invention is provided. Instead of having to lift the bottom end of the paddock blade 101 to dump the contents the operator merely steps on the release of a latch 106 and the lifting assembly dumps the contents of the paddock blade 101 for them.

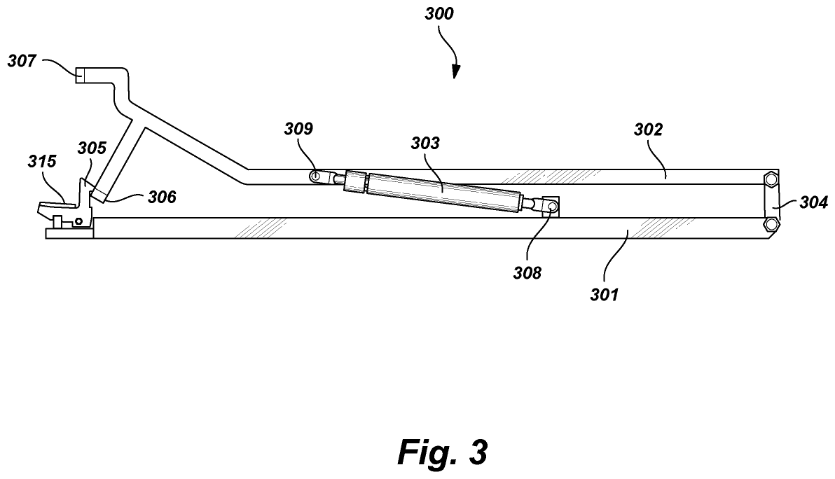

The lifting assembly of the self-dumping paddock blade 100 comprises a lower frame 102 and an upper frame 103. Both frames 102 and 103 have a general U shape and are releasably attached at the bottom of the U's by a latch 106. The terminal ends of both U-shaped frames 102 and 103 are rotatably connected; one of the connections 105 is shown in FIG. 1. Two pre-tensioned gas struts, including gas strut 104, provide the lifting force for lifting the paddock blade 101 when the latch 106 is released. A more detailed description of the lifting assembly is provided in association with FIGS. 3-6.

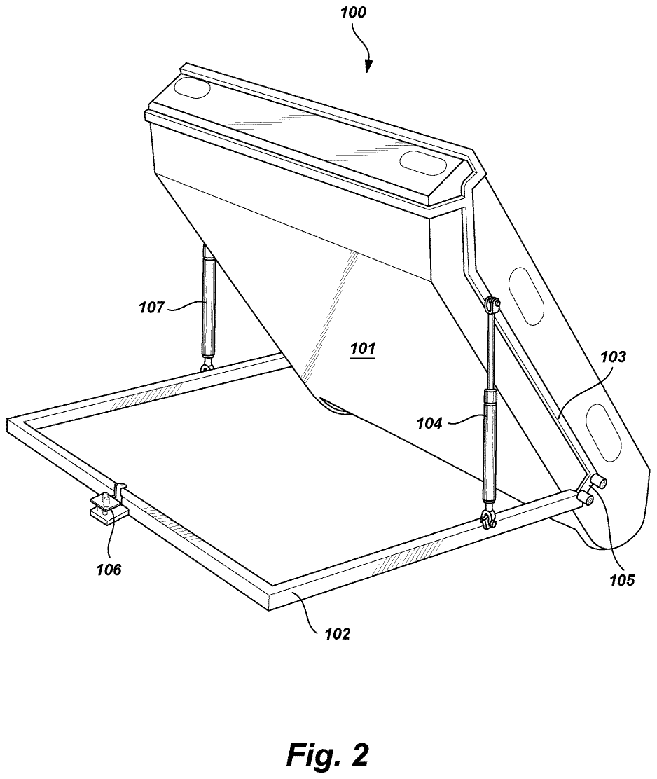

FIG. 2 is a perspective view of the preferred embodiment of the present self-dumping paddock blade 100 in the raised position. After the operator releases the latch 106, the two pre-tensioned gas struts 104 and 107 push the upper frame 103 upward. Since the terminal ends of the frames 102 and 103 are connected, such as by connection 105, only the bottom part of upper frame 103 rises, along with the sides of the frame 103 near the bottom. The upper frame 103 is attached to the paddock blade 101 so the bottom end of the blade 101 is raised into the air, as well. The open end of the paddock blade 101, near connection 105, remains at ground level and the contents of the blade 101 are dumped out by gravity. The lower frame 102 of the lifting assembly pushes against the ground when the paddock blade 101 is raised and provides a sturdy base for the two pre-tensioned gas struts 104 and 107.

The paddock blade 101 is preferably made of metal or a metallic alloy. Similarly, the upper and lower frames are preferably made of metal or a metallic alloy. The two pre-tensioned gas struts preferably provide a lifting force that is equal to, or greater than, the weight of the paddock blade 101 plus the maximum weight of a load. Pre-tensioned gas struts currently available on the market, such as the Gas spring 14-28 Stroke 300 available at GasSpringShop.com, can provide a lifting force of 560 lbs. each. Two of this type of pre-tensioned gas strut would be more than capable of providing the force needed in the self-dumping paddock blade 100.

FIG. 3 is a side view of an alternative embodiment of the present invention in the lowered position. The alternative embodiment of the present invention is the lifting assembly 300 by itself. The lifting assembly 300 can be attached to any existing paddock blade. The bottom portion 307 of the upper frame 302 is attached to the closed end of the paddock blade. Preferably, the terminal end of the frame 302, near the rotatable connection 304, is also attached to the paddock blade. The lifting assembly 300 is attached so that the assembly 300 rides just above ground level during manure collection, to reduce drag. The bottom portion 306 of the upper frame 302 is connected to the bottom of the lower frame 301 by a latch 305. The latch 305 preferably includes a foot pedal 315 that, when stepped on, releases the bottom portion 306 of the upper frame 302 from the lower frame 301. The bottom portion 306 then rises into the air thanks to the two pre-tensioned gas struts; one of the gas struts 303 is shown in FIG. 3. The pre-tensioned gas strut 303 has a lower end 308 that is attached to the lower frame 301, and an upper end 309 that is attached to the upper frame 302. The lower end 308 of the gas strut 303 is attached to the lower frame 301 at a point that is closer to the terminal end of the frame 301. The terminal end of the frame 301 is connected to the rotatable connection 304. The upper end 309 of the gas strut 303 is attached to the upper frame 302 at a point that is further away from the terminal end of the frame 302. The terminal end of the frame 302 is also attached to the rotatable connection 304. This positioning allows the pre-tensioned gas struts to raise the bottom portion 306 of the upper frame 302 when the foot pedal 315 is stepped on and the latch 305 is released.

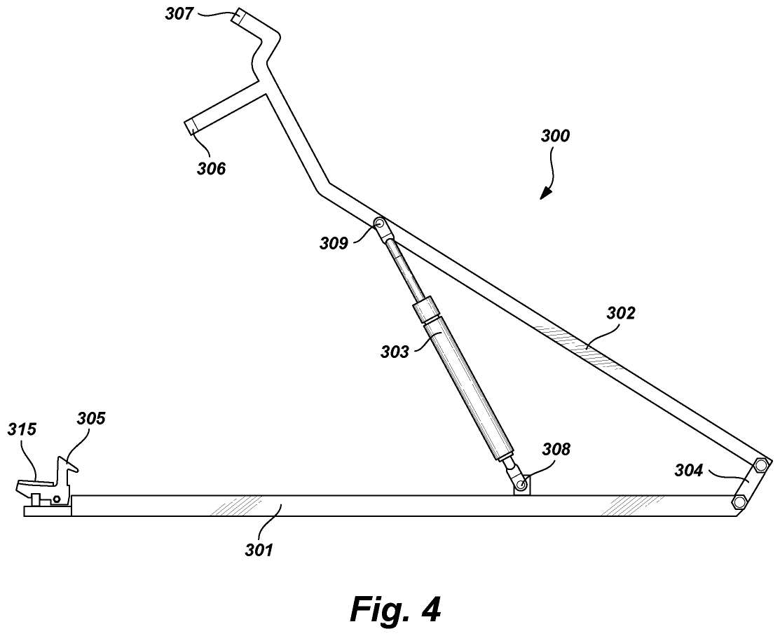

FIG. 4 is a side view of the alternative embodiment of the present invention in the raised position. The lifting assembly 300 attains the raised position after the foot pedal 315 of the latch 305 is pressed. Release of the latch 305 allows the upper end 309 of the pre-tensioned gas strut 303 to push upward on the upper frame 302 and raise the bottom portion 306 of the frame 302 into the air. The lower end 308 of the gas strut 303 is attached to the lower frame 301 of the lifting assembly 300. The lower frame 301 presses against the ground during a dumping operation thereby providing a solid base for the pre-tensioned gas strut 303.

The lower frame 301 and the upper frame 302 are preferably made of metal or a metallic alloy. The two pre-tensioned gas struts preferably provide a lifting force that is equal to, or greater than, the weight of an average paddock blade plus the maximum weight of a load. Pre-tensioned gas struts currently available on the market, such as the Gas spring 14-28 Stroke 300 available at GasSpringShop.com, can provide a lifting force of 560 lbs. each. Two of this type of pre-tensioned gas strut would be more than capable of providing the force needed for the lifting assembly 300.

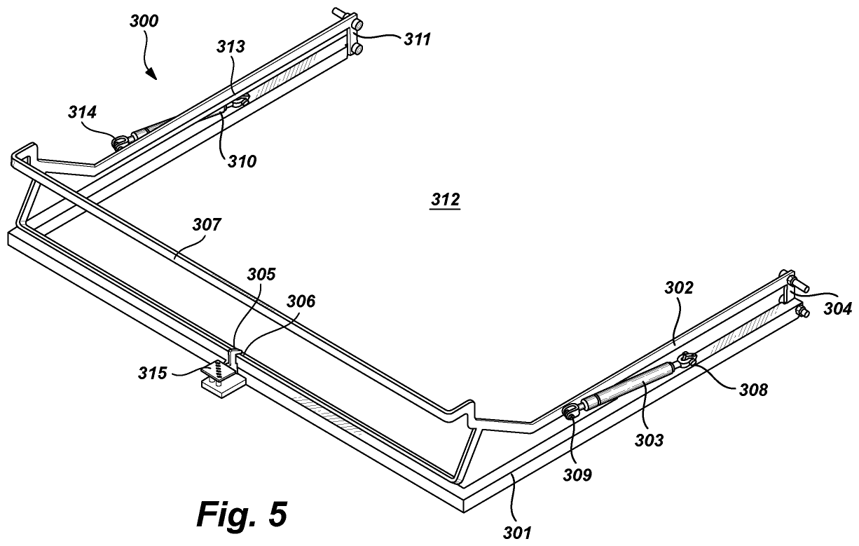

FIG. 5 is a perspective view of the alternative embodiment of the present invention in the lowered position. This perspective view of the lifting assembly 300 shows the empty space 312 inside the lifting assembly 300 that will be taken up by a paddock blade when one is attached. The paddock blade is preferably attached to the bottom portion 307 of the upper frame 302 and to the two terminal ends of the upper frame 302, near the rotatable connections 304 and 311. The lower frame 301 includes a latch 305 that latches to the bottom portion 306 of the upper frame 302. The latch 305 preferably includes a foot pedal 315 that the operator can step on to release the latch 305. The latch 305 holds down the upper frame 302, which is under pressure from the two pre-tensioned gas struts 303 and 310. The gas struts 303 and 310 have lower ends 308 and 313 that are connected to the lower frame 301, at points that are closer to the rotatable connections 304 and 311. The pre-tensioned gas struts 303 and 310 also have upper ends 309 and 314 that are connected to the upper frame 302, at points that are further away from the rotatable connections 304 and 311.

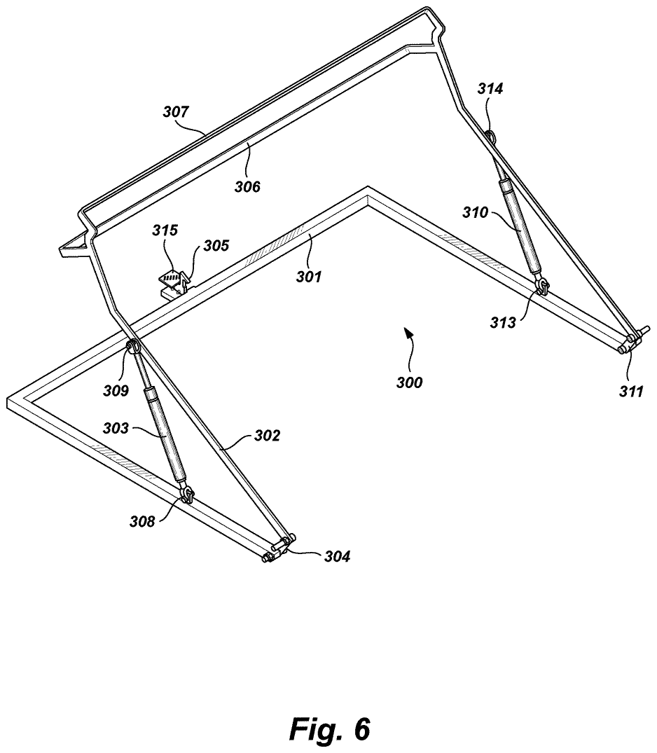

FIG. 6 is a perspective view of the alternative embodiment of the present invention in the raised position. When the operator steps on the foot pedal 315 of the latch 305, the bottom portion 306 of the upper frame 302 is released and the pre-tensioned gas struts 303 and 310 push upward on the upper frame 302, raising the bottom portions 306 and 307 of the frame 302 into the air. The raised position of the lifting assembly 300 is the dumping position when a paddock blade is attached. The paddock blade is attached to the upper frame 302 with the closed end of the blade attached to the bottom portion 307 and the open end of the blade attached near the rotatable connections 304 and 311. When the lifting assembly 300 is in the raised position, gravity is used to dump the contents out of the open end of the paddock blade and onto the ground.

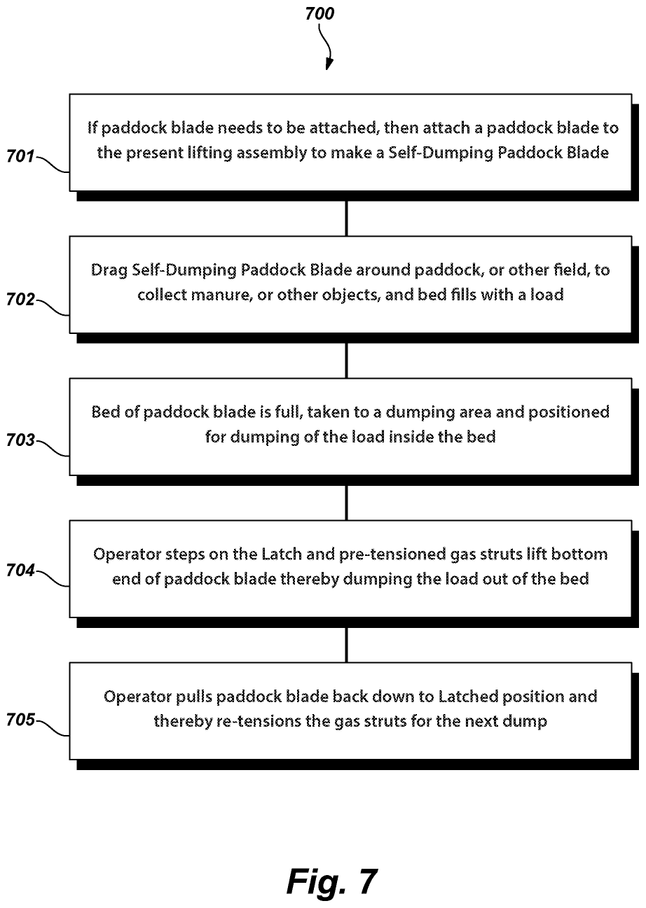

FIG. 7 is a flow chart 700 showing exemplary steps for using the present invention. The present lifting assembly can come already attached to a paddock blade, or the lifting assembly can be provided by itself. If the lifting assembly is provided by itself, then in step 701, a paddock blade is attached, making a Self-Dumping Paddock Blade. In step 702, the Self-Dumping Paddock Blade is dragged through a paddock, pasture or other field and a load of manure, or other objects, is gathered in the bed of the blade. Then, in step 703, the Self-Dumping Paddock Blade is taken to a dumping area and positioned for dumping the load. In step 704, the operator steps on the foot pedal of the latch, and the two pre-tensioned gas struts raise the bottom end of the paddock blade and dump the load out of the bed of the paddock blade. Finally, in step 705, the operator pulls the paddock blade back down to the latched position and re-tensions the gas struts for the next dump. The Self-Dumping Paddock Blade is then ready for another collection and self-dumping operation.

While a particular form of the invention has been illustrated and described, it will be apparent that various modifications can be made without departing from the spirit and scope of the invention. For example, the pre-tensioned gas struts could be replaced with pre-loaded spring struts. Accordingly, the appended claims are intended to embrace all such alternatives, modifications, variations, improvements, and substantial equivalents.

What is claimed is:

1. A dumping assembly that is adapted for attachment to a paddock blade, wherein after attachment, the paddock blade is capable of dumping its load without any lifting being required by an operator, the dumping assembly comprising:
a lower frame having a U shape; an upper frame having a similar U shape; two pre-tensioned gas struts, wherein each gas strut has a lower end that is connected to the lower frame and an upper end that is connected to the upper frame, and
wherein the lower and upper frames are rotatably connected at terminal ends of the frames, and further wherein the frames are releasably connected at bottom ends of the frames, and wherein the pre-tensioned gas struts cause the bottom end of the upper frame to rise, when a latch at the bottom end of the frames is pressed, thereby releasing the upper frame from the bottom frame.

2. The dumping assembly of claim 1, wherein the latch includes a foot pedal, and stepping on the foot pedal releases the latch.

3. The dumping assembly of claim 1, wherein the lower ends of the pre-tensioned gas struts are connected to the lower frame at points that are closer to the terminal ends of the frame, and the upper ends of the gas struts are connected to the upper frame at points that are further away from the terminal ends of the frame.

4. The dumping assembly of claim 1, wherein the upper frame of the dumping assembly is adapted for attachment to the paddock blade.

5. The dumping assembly of claim 1, wherein the lower frame and the upper frame are both made of metal or a metallic alloy.

6. A self-dumping paddock blade that is able to dump its load without any lifting being required by an operator, the self-dumping paddock blade comprising:
a paddock blade that is adapted to be dragged through a paddock whereby a load is gathered inside a bed of the paddock blade;
a dumping assembly that is attached to an exterior of the paddock blade, the dumping assembly comprising:
a lower frame having a U shape; an upper frame having a similar U shape; and, two pre-tensioned gas struts, wherein each gas strut has a lower end that is connected to the lower frame and an upper end that is connected to the upper frame, and
wherein the lower and upper frames are rotatably connected at terminal ends of the frames, and further wherein the frames are releasably connected at bottom ends of the frames, and wherein the pre-tensioned gas struts cause the bottom end of the upper frame to rise, when a latch at the bottom end of the frames is pressed, thereby releasing the upper frame from the bottom frame.

7. The self-dumping paddock blade of claim 6, wherein the latch includes a foot pedal, and stepping on the foot pedal releases the latch.

8. The self-dumping paddock blade of claim 6, wherein the lower ends of the pre-tensioned gas struts are connected to the lower frame at points that are closer to the terminal ends of the frame, and the upper ends of the gas struts are connected to the upper frame at points that are further away from the terminal ends of the frame.

9. The self-dumping paddock blade of claim 6, wherein the upper frame of the dumping assembly is attached to the paddock blade.

10. The self-dumping paddock blade of claim 6, wherein the lower frame and the upper frame are both made of metal or a metallic alloy.

11. A method for providing a self-dumping paddock blade that allows for a load to be dumped without requiring any lifting by an operator, the method comprising the steps of:
providing a paddock blade that is adapted to be dragged through a paddock whereby a load is gathered inside a bed of the paddock blade; and,
providing a dumping assembly that is attached to an exterior of the paddock blade, the dumping assembly comprising:
a lower frame having a U shape; an upper frame having a similar U shape; and two pre-tensioned gas struts, wherein each gas strut has a lower end that is connected to the lower frame and an upper end that is connected to the upper frame;
wherein the lower and upper frames are rotatably connected at terminal ends of the frames, and further wherein the frames are releasably connected at bottom ends of the frames, and wherein the pre-tensioned gas struts cause the bottom end of the upper frame to rise, when a latch at the bottom end of the frames is pressed, thereby releasing the upper frame from the bottom frame.

12. The method of claim 11, further comprising the step of:
providing the latch with a foot pedal, and stepping on the foot pedal releases the latch.

13. The method of claim 11, further comprising the steps of:
connecting the lower ends of the pre-tensioned gas struts to the lower frame at points that are closer to the terminal ends of the frame; and,
connecting the upper ends of the gas struts to the upper frame at points that are further away from the terminal ends of the frame.

14. The method of claim 11, further comprising the step of:
attaching the upper frame of the dumping assembly to the paddock blade.

15. The method of claim 11, wherein the lower frame and the upper frame are both made of metal or a metallic alloy.
